(19) United States
(12) Patent Application Publication
(10) Pub. No.: US 2004/0196414 A1
(43) Pub. Date: Oct. 7, 2004

(54) Diffusion reflector having Ti02 layer and process for manufacturing the same

(75) Inventors: Chi-Chang Liao, Hsinchu (TW); Ming-Daw Chen, Hsinchu (TW); Liang-Ying Huang, Hsinchu (TW); Yi-Chun Wong, Hsinchu (TW); Yaw-Ting Wu, Hsinchu (TW); Ming-Lang Tsai, Hsinchu (TW); Chun-Hsiang Wen, Hsinchu (TW); Hsien-Kuang Lin, Hsinchu (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/637,696

(22) Filed: Aug. 11, 2003

(30) Foreign Application Priority Data
Apr. 4, 2003 (TW) 092107808

(51) Int. Cl. G02F 1/1335

(52) U.S. Cl. 349/64; 264/2.1; 264/1.9

(57) ABSTRACT

A diffusion reflector having a TiO₂ layer and a process for manufacturing the same are proposed. The TiO₂ layer is disposed on a diffusion reflector by coating, electroplating or plasma enhanced chemical vapor deposition process. The directional dependency of the reflector on external luminosity is reduced and the resulting appearance of the reflector looks like the appearance of white paper.

### FIELD OF THE INVENTION

A diffusion reflector having a TiO₂ layer and a process for manufacturing the same, wherein various manufacturing processes are utilized for disposing titanium oxides on a diffusion reflector of a liquid crystal display substrate.

### BACKGROUND OF THE INVENTION

Base on the development of fundamental science theory, image display technology has made tremendous progress both in hardware and software. In the past decades, the image display has evolved from black and white cathode ray tube (CRT) to color CRT, and from spherical tube to flat square tube. In recent years, The bulky display device, which has been popular for years, CRT, is now gradually replaced by compact and portable liquid crystal display (LCD) or plasma display.

The price of a LCD and plasma display television is more expensive than a traditional television. However, they emit less radiation and provide higher display resolution. It is expected that after the market enters into the mass manufacturing stage, the price difference between traditional television, LCD and plasma display television will be greatly reduced. As a result, the LCD and plasma display television will be more competitive by that time.

Recently, protable information tools, such as personal digital assistant, hand-held personal computer, and digital camera, are widespread. These have created a new market for high quality and low power consumption flat panel displays. Full-color reflective LCDs have the merits of low power consumption, light weight, compact size and good legiblity under the sunlight. In the reflective LCD, LC mode and reflector are two performance-dominating components. ERSO/ITRI has spent a great amount of efforts in developing a new type highhly efficiency reflector-internal diffusive micro slant reflector (DMSR) structure. Flexible displays have an advantage over rigid ones in their way of application. It is significant to improve the characteristic of the reflector for paper-like displays.

### SUMMARY OF THE INVENTION

The main objective of the present invention is to provide a diffusion reflector having a TiO₂ layer, for developing paper-like displays. The other objective of the present invention is to provide a liquid crystal display substrate with titanium oxides disposed thereon. By unitizing the property of titanium oxides, not only the dependency on luminosity direction can be reduced, but also the resulting appearance of the liquid crystal display can look like the appearance of white paper.

The invention can be more fully understood by reading the following detailed description of the preferred embodiments, with reference made to the accompanying drawings.

### BRIEF DESCRIPTION OF THE DRAWINGS

FIG. 1 is a schematic view of the sectional structure according to the first embodiment of the present invention;

FIG. 2 is a manufacturing flow chart according to the first embodiment of the present invention;

FIG. 3 is a schematic view of the sectional structure according to the second embodiment of the present invention;

FIG. 4 is a manufacturing flow chart according to the second embodiment of the present invention;

FIG. 5 is a schematic view of the sectional structure according to the third embodiment of the present invention;

FIG. 6 is a manufacturing flow chart according to the third embodiment of the present invention.

### DETAILED DESCRIPTION OF THE PREFERRED EMBODIMENTS

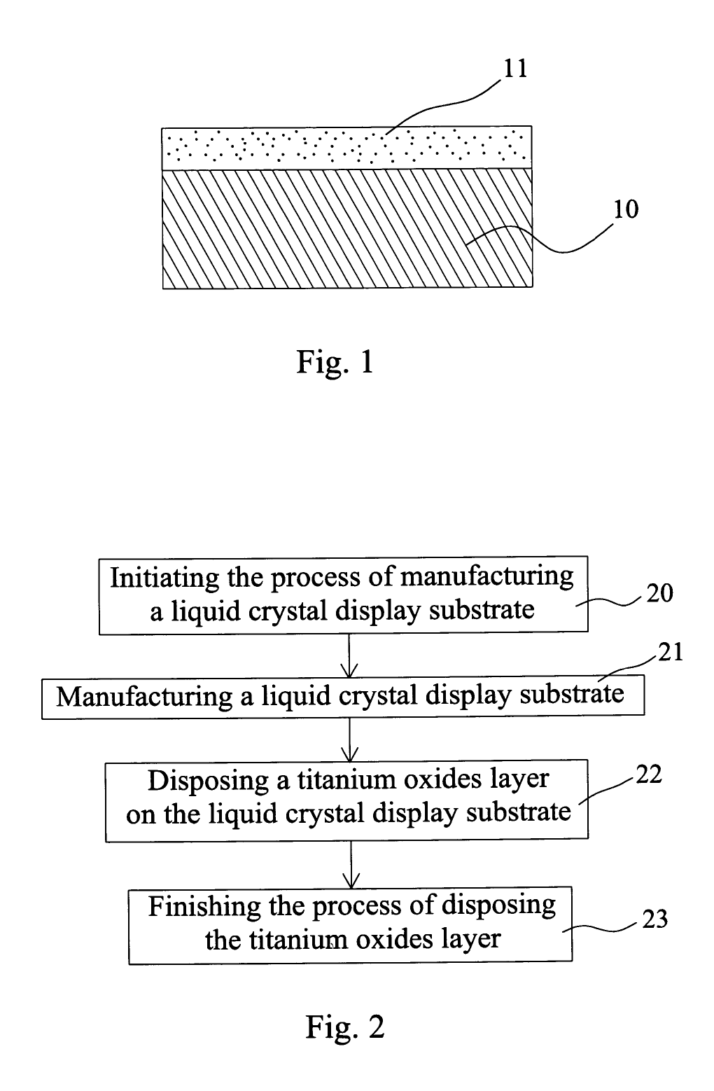

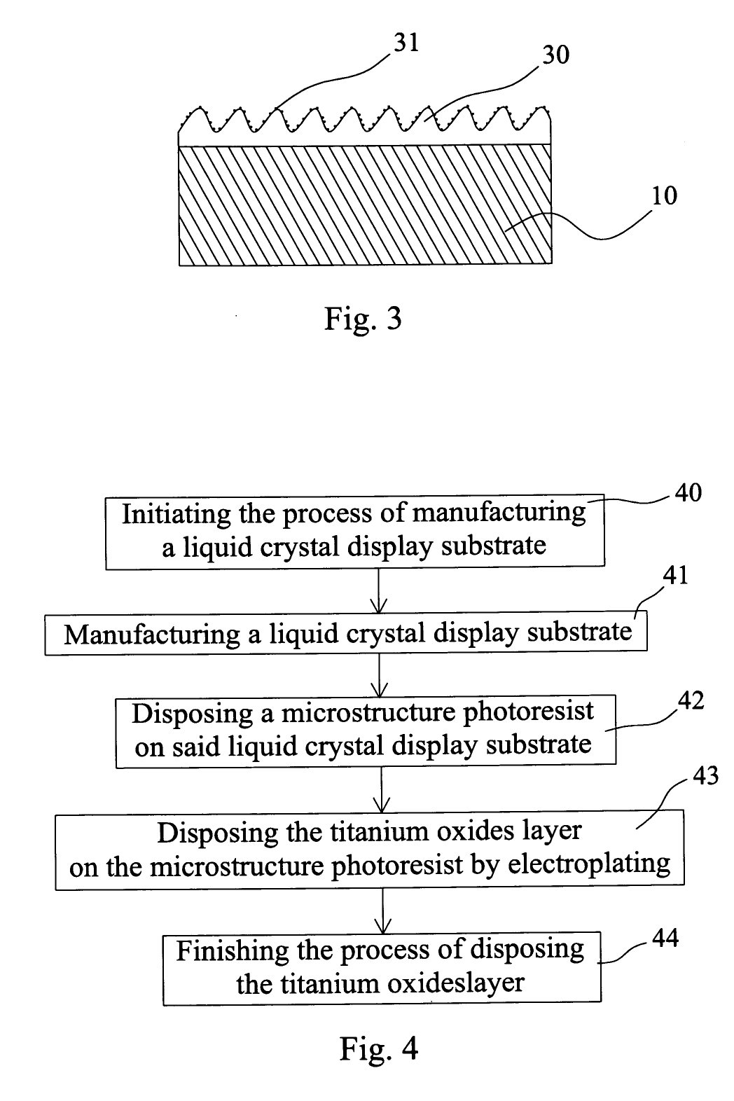

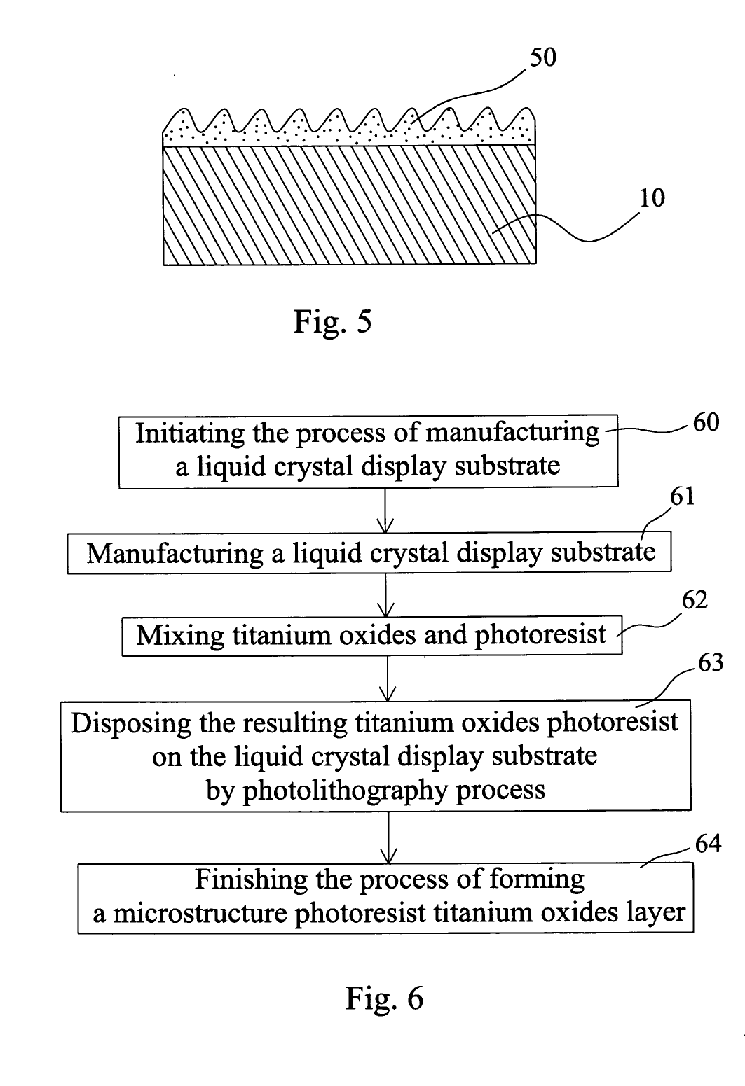

The present invention relates to diffusion TiO₂ reflector wherein the property of the titanium oxides is utilized. By disposing a titanium oxides layer on the reflector in the LCD, the deteriorated display due to the dependency of luminosity direction of the reflector in a LCD can be eliminated. FIG. 1 is a schematic view of the sectional structure according to the first embodiment of the present invention. According to FIG. 1, the present invention comprises a liquid crystal display substrate 10, wherein a layer of titanium oxides (TiO₂) 11 is provided on the liquid crystal display substrate 10. A process of manufacturing a diffusion reflector having a TiO₂ Layer provides the liquid crystal display substrate 10. The liquid crystal display substrate 10 can be composed of aluminum or general materials used for manufacturing semiconductor substrate. FIG. 2 is a manufacturing flow chart according to the first embodiment of the present invention. The process for disposing a titanium oxides layer on the liquid crystal display substrate comprises steps as: step 20: initiating the process of manufacturing a liquid crystal display substrate, step 21: manufacturing a liquid crystal display substrate, step 22: disposing a titanium oxides layer on the liquid crystal display substrate, and step 23: finishing the process of disposing the titanium oxides layer. In step 22, the step further comprises the process of disposing the titanium oxides layer by spin coating used in ordinary process. FIG. 3 is a schematic view of the sectional structure according to the second embodiment of the present invention. According to FIG. 3, a layer of microstructure photoresist 30 is disposed on the liquid crystal display substrate 10. Because the microstructure photoresist 30 is further disposed on the titanium oxides layer 31, the dependency on the luminosity direction of the diffusion reflector in the LCD can be eliminated by the scattering property of microstructure photoresist 30. As a result, not only the deteriorated display is corrected by disposing the titanium oxides layer 30, also the resulting appearance of the liquid crystal display can look like the appearance of white paper. FIG. 4 is a manufacturing flow chart according to the second embodiment of the present invention. Similar to the first embodiment, the process comprises steps as: step 40: initiating the process of manufacturing a liquid crystal display substrate, step 41: manufacturing a liquid crystal display substrate, then, it is followed by step 42: disposing a microstructure photoresist on said liquid crystal display substrate, and step 43: disposing the titanium oxides layer on the microstructure photoresist by electroplating. By completing the steps mentioned above, the process for manufacturing a diffusion reflector for an LCD according to the second embodiment is completed. It should be noted that the method for disposing a titanium oxides layer is not only limited to electroplating, a method of semi-scattering plasma enhanced chemical vapor deposition can also be used. FIG. 5 is a schematic view of the sectional structure according to the third embodiment of the present invention. The third embodiment is similar to the second embodiment, a liquid crystal display substrate 10 is provided. Also, a microstructure photoresist titanium oxides layer 50 is disposed on the liquid crystal display substrate 10. The microstructure photoresist titanium oxides layer 50 is the mixture of titanium oxides and photoresist. By a process step for disposing the mixture on the liquid crystal display substrate 10, the microstructure photoresist titanium oxides layer 50 is provided. By implementing third embodiment of the present invention, not only the deteriorated display due to the directional dependency on external luminosity is accordingly reduced, but also the resulting appearance of the liquid crystal display can look like the appearance of white paper. FIG. 6 is a manufacturing flow chart according to the third embodiment of the present invention. The flow begins with step 60: initiating the process of manufacturing a liquid crystal display substrate, then step 61: manufacturing a liquid crystal display substrate, followed by step 62: mixing titanium oxides and photoresist, then step 63: disposing the resulting titanium oxides photoresist on the liquid crystal display substrate by photolithography process to form a microstructure photoresist titanium oxides layer. Therefore, the implementing steps incorporated in the third embodiment as mentioned above provides a diffusion reflector. It should be noted that the mixture of the titanium oxides and the photoresist is completed by scattering extrusion. In the second and the third embodiment, the diffusion reflector provided contains micro slant property, accordingly is capable of light reflecting and scattering, and increases display quality. The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1 A diffusion reflector having a TiO₂ layer comprises: a liquid crystal display substrate prepared by a process for a manufacturing diffusion liquid crystal reflecting panel; a titanium oxides (TiO₂) layer, disposed on the liquid crystal display substrate; whereby a diffusion liquid crystal display panel for a liquid crystal display is provided by a combination of said structures.

2. The diffusion reflector having a TiO₂ layer of claim 1, wherein said liquid crystal display substrate is composed of aluminum.

3. The diffusion reflector having a TiO₂ layer of claim 1, wherein said titanium oxides layer is disposed on the liquid crystal display substrate by a spin coating process.

4. The diffusion reflector having a TiO₂ layer of claim 1, wherein a microstructure photoresist is further disposed on said liquid crystal display substrate.

5. The diffusion reflector having a TiO₂ layer of claim 4, wherein the titanium oxides layer is disposed on the directional photoresist by a plasma enhanced chemical vapor deposition (PEVCD) process.

6. The diffusion reflector having a TiO₂ layer of claim 4, wherein said titanium oxides layer is mixed with the microstructure photoresist by scattering extrusion and disposed on the liquid crystal display substrate.

7. A process for manufacturing a diffusion TiO₂ reflector, comprising the following steps:
manufacturing a liquid crystal display substrate; and disposing a titanium oxides layer on the liquid crystal display substrate.

8. The process for manufacturing a diffusion TiO₂ reflector of claim 7, wherein the step of disposing a titanium oxides layer on the liquid crystal display substrate is completed by spin coating.

9. The process for manufacturing a diffusion TiO₂ reflector of claim 7, wherein the step of disposing a titanium oxides layer on the liquid crystal display substrate is completed by electroplating the titanium oxides layer on the liquid crystal display substrate.

10. The process for manufacturing a diffusion TiO₂ reflector of claim 7, wherein the step of manufacturing a liquid crystal display substrate further comprises a step of disposing a microstructure photoresist on the liquid crystal display substrate.

11. The process for manufacturing a diffusion TiO₂ reflector of claim 10, wherein the step of disposing a titanium oxides layer on the liquid crystal display substrate is completed by plasma enhanced chemical vapor deposition for disposing the titanium oxides layer on the microstructure photoresist in a semi scattering manner.

12. The process for manufacturing a diffusion TiO₂ reflector of claim 11, wherein the step of disposing a titanium oxides layer on the liquid crystal display substrate further comprises the step of disposing mixture of titanium oxides layer and the microstructure photoresist by photolithography process after the titanium oxides layer is mixed with the microstructure photoresist by scattering extrusion.
